(19) United States
(12) Patent Application Publication
(10) Pub. No.: US 2007/0254609 A1
(43) Pub. Date: Nov. 1, 2007

(54) Wireless Switch With Uninterruptible Power Supply

(75) Inventors: Josh Rosenthal, San Jose, CA (US); Sameer Kanagala, San Carlos, CA (US); Edward Geiger, San Martin, CA (US); Michael Suekawa, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: SYMBOL TECHNOLOGIES, INC., Holtsville, NY (US)

(21) Appl. No.: 11/741,834

(22) Filed: Apr. 30, 2007

Related U.S. Application Data
(60) Provisional application No. 60/797,018, filed on May 1, 2006.

(51) Int. Cl. H04B 1/04

(52) U.S. Cl. 455/127.1

(57) ABSTRACT

A wireless switch for a wireless network is disclosed herein. The wireless switch includes a housing for a number of electrical components and other elements. The wireless switch includes an integrated uninterruptible power supply (UPS) inside the housing, where the integrated UPS provides backup operating power to the components of the wireless switch as needed. The wireless switch can detect a failure condition of the primary power supply and, in response to the detected failure condition, activate the integrated UPS such that the wireless switch can seamlessly transition to its backup power supply without an interruption in service.

### CROSS-REFERENCE TO RELATED APPLICATION(S)

This application claims the benefit of U.S. provisional patent application Ser. No. 60/797,018, filed May 1, 2006.

### TECHNICAL FIELD

Embodiments of the subject matter described herein relate generally to a wireless switch suitable for use in a wireless local area network (WLAN). More particularly, embodiments of the subject matter relate to a wireless switch having an integrated uninterruptible power supply (UPS) that provides backup operating power as needed.

### BACKGROUND

There has been a dramatic increase in demand for mobile connectivity solutions utilizing various wireless components and WLANs. This generally involves the use of wireless access points that communicate with mobile devices using one or more RF channels. A WLAN may operate in accordance with one or more of the IEEE 802.11 standards.

WLANs can give clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices. Conventional wireless switches generally function as network interfaces between wireless access devices and a traditional computer network, such as a local area network (LAN).

In most practical applications, wireless switches obtain operating power from standard AC voltage sources (for example, the standard commercial or household 120 volt AC supply available in the United States). Conventional wireless switches are limited in that they depend upon the integrity and robustness of the operating power source. If the operating power source fails, spikes, or dips, then a conventional wireless switch will react accordingly by shutting down, cycling, or otherwise failing. External surge protection devices or systems and/or external backup power supply solutions can be utilized in conjunction with such conventional wireless switches. Unfortunately, such external equipment can be expensive, bulky, heavy, and difficult to install.

Wireless switching systems are used in connection with access ports and/or access points that communicate wirelessly with associated mobile units. Older wireless switching systems are unsatisfactory in a number of respects, and it is thus desirable to provide improved systems for controlling wireless devices.

### BRIEF SUMMARY

A wireless switch configured as described herein can be deployed to support a WLAN. The wireless switch includes an integrated UPS that enables the wireless switch to remain operational in the event of a primary power supply failure (e.g., a shutdown, a voltage spike, a voltage dip, etc.). The integrated UPS is contained within the main housing of the wireless switch to provide a sleek overall appearance. In response to a failure condition of the primary power supply, the integrated UPS is activated to provide backup DC operating power to the various electrical components of the wireless switch.

The above and other aspects may be carried out by an embodiment of a wireless switch for a wireless network. The wireless switch includes an integrated UPS that is configured to provide operating power for components of the wireless switch in response to a failure condition of a primary power supply for the wireless switch.

The above and other features may be carried out by an embodiment of a power management method for a wireless switch. The method involves: operating the wireless switch with a primary power supply; detecting a failure condition of the primary power supply; in response to detecting the failure condition, activating an integrated UPS in the wireless switch; and operating the wireless switch with the integrated UPS.

The above and other features may be implemented in an embodiment of a wireless switch for a wireless network. The wireless switch includes: a housing; a plurality of components inside the housing; a power supply architecture for the plurality of components; a primary power supply interface coupled to the power supply architecture, the primary power supply interface being configured for compatibility with a primary power supply for the wireless switch; and an integrated UPS inside the housing. The integrated UPS is coupled to the power supply architecture, and the integrated UPS is configured to provide backup operating power for the plurality of components in response to a failure condition of the primary power supply.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a computer network having a wireless switch;

FIG. 2 is a front panel perspective view of an embodiment of a wireless switch;

FIG. 3 is a rear panel perspective view of the wireless switch shown in FIG. 2;

FIG. 4 is a schematic representation of an embodiment of a wireless switch;

FIG. 5 is a schematic representation of an embodiment of a UPS suitable for integration with the wireless switch depicted in FIG. 4; and

FIG. 6 is a flow chart that illustrates an embodiment of a power management process for a wireless switch.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of network topologies and wireless switch configurations, and that the system described herein is merely one suitable example.

For the sake of brevity, conventional techniques related to WLANs, data transmission, signaling, network control, wireless access device operation, wireless switch operation, uninterruptible power supplies, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the subject matter.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 3 depicts one example arrangement of elements, additional intervening elements, devices, features, or components may be present in an embodiment of the depicted subject matter.

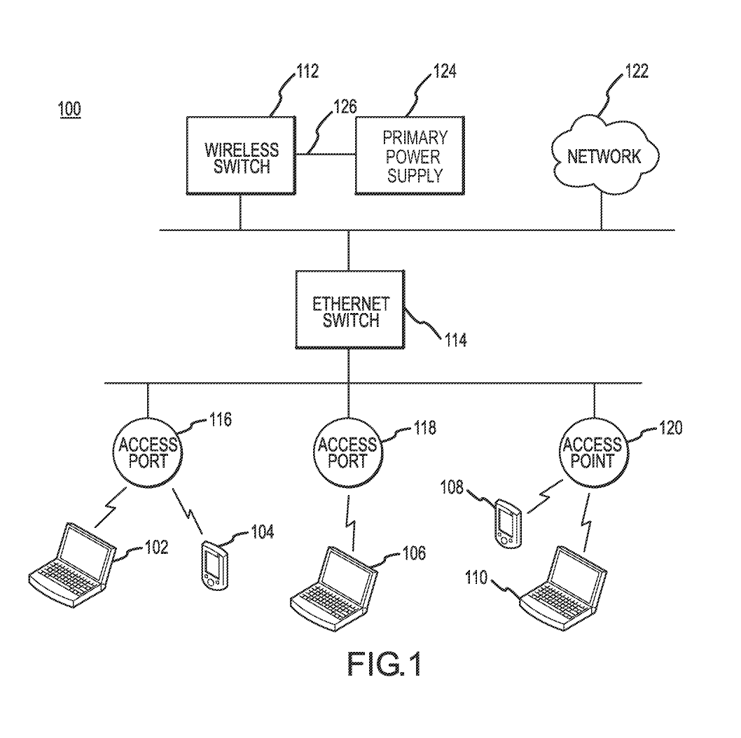

FIG. 1 is a schematic representation of an embodiment of a computer network 100. In this example, computer network 100 includes a WLAN. Computer network 100 generally includes wireless clients (identified by reference numbers 102, 104, 106, 108, and 110), a wireless switch 112, an Ethernet switch 114, and a number of wireless access devices (identified by reference numbers 116, 118, and 120). Computer network 100 may also include or communicate with any number of additional network components, such as a traditional local area network (LAN). In FIG. 1, such additional network components are generally identified by reference number 122. A practical embodiment can have any number of wireless switches, each supporting any number of wireless access devices, and each wireless access device supporting any number of wireless clients. Indeed, the topology and configuration of computer network 100 can vary to suit the needs of the particular application and FIG. 1 is not intended to limit the application or scope of the invention in any way.

In this example, wireless access devices 116/118 are realized as wireless access ports, which are “thin” devices that rely on the network intelligence and management functions provided by wireless switch 112, while wireless access device 120 is realized as a wireless access point, which is a “thick” device having the network intelligence and processing power integrated therein. Thus, wireless access point 120 need not rely upon wireless switch 112 for operation. Wireless access ports having conventional features that can be incorporated into wireless access devices 116/118, and wireless access points having conventional features that can be incorporated into wireless access device 120 are available from Symbol Technologies, Inc. Briefly, a wireless access device as described herein is suitably configured to receive data from wireless clients over wireless links. Once that data is captured by the wireless access device, the data can be processed for communication within computer network 100. For example, the data can be encapsulated into a packet format compliant with a suitable data communication protocol. In the example embodiment, data is routed within computer network 100 using conventional Ethernet 802.3 addressing (including standard Ethernet destination and source packet addresses).

In this embodiment, wireless switch 112 is coupled to Ethernet switch 114, which is in turn coupled to wireless access devices 116/118/120. In practice, wireless switch 112 communicates with wireless access devices 116/118 via Ethernet switch 114. A given wireless switch can support any number of wireless access devices, i.e., one or more wireless access devices can be concurrently adopted by a single wireless switch. In this embodiment, a wireless access device can be adopted by only one wireless switch at a time; this feature dictates that a wireless access device (station) can only be associated with a single access point while an access point can adopt multiple stations. The wireless clients are wireless devices that can physically move around computer network 100 and communicate with network components 122 via wireless access devices 116/118/120.

Wireless switch 112 receives its operating power from a primary power supply 124. In practice, primary power supply 124 may represent a standard commercial or household AC voltage source that is configured to provide an AC voltage to wireless switch 112 (for example, an ordinary 120 volt, 60 Hz, AC source). Wireless switch 112 may utilize a suitably configured power cord 126 that enables it to be plugged into a standard AC wall socket. Under normal operating conditions, wireless switch 112 utilizes primary power supply 124 to power its electrical components. As used herein, “primary power supply” may also refer to the main internal operating power of wireless switch 112 that is derived from an external AC voltage source. In other words, “primary power supply” may refer to the normal and ordinary power supply used by wireless switch 112 (in contrast to any backup power supply that might be used).

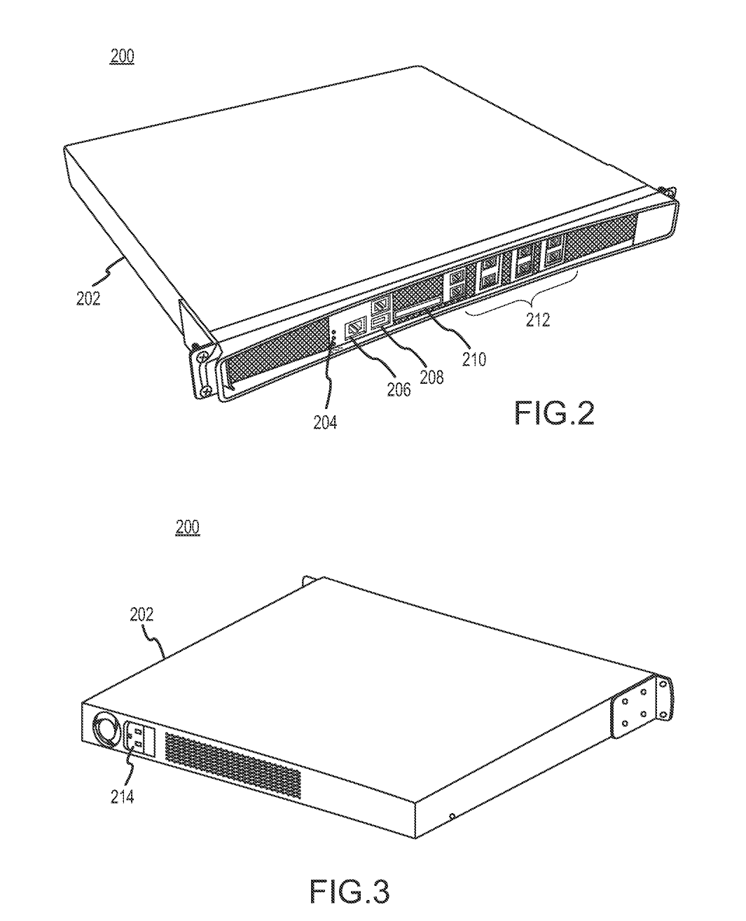

FIG. 2 is a front panel perspective view of an embodiment of a wireless switch 200, which is suitable for use in a network such as computer network 100, and FIG. 3 is a rear panel perspective view of wireless switch 200. Wireless switch 200 includes various advantageous features. For example, wireless switch 200 may utilize a field programmable gate array (FPGA) to perform certain logic functions within the switch. In addition, a computer-based processor may be included within wireless switch 200—i.e., an application processor serving as an adjunct to the processor running the switch software. This allows, for example, a server to be incorporated into wireless switch 200. The processor might also be a voice processor and a DSP interface, thereby creating a PBX within the switch.

Wireless switch 200 may also be suitably configured to accept a CompactFlash card or other portable nonvolatile memory device. The nonvolatile memory storage device includes code, data, etc. that assists with reloading wireless switch 200 after initial switch activation. Additionally or alternatively, a USB port can be included on the exterior of wireless switch 200 for interfacing with one or more USB devices. For example, a memory stick or other USB drive may be used to transfer information and/or code from or to wireless switch.

Another feature of wireless switch 200 relates to the use of a switch incorporating a boot halt. That is, the user is allowed to halt the boot process in order to enter a diagnostic mode, thereby allowing advanced troubleshooting. In accordance with another feature of wireless switch 200, booting is initiated via a NAND device rather than a NOR device as used in existing wireless switch devices.

In the embodiment described in more detail below, wireless switch 200 incorporates an integrated uninterruptible power source (UPS). The UPS provides a backup power supply in the event of a power failure. It can provide power for a specified period or just enough power for proper power-down of wireless switch 200.

In another embodiment, a locator light is incorporated into wireless switch 200. That is, a switch or other feature is provided on one side of wireless switch 200 (e.g., the face), wherein activation of the switch results in a light (LED, etc.) being activated on another surface (e.g., the back) of wireless switch 200.

A practical embodiment of wireless switch 200 will include components and elements configured to support known or conventional operating features that need not be described in detail herein. In the example embodiment, wireless switch 200 communicates with wireless access devices and wireless switch 200 provides the switching intelligence and processing logic to ensure that data for a given communication session is directed to and from the correct wireless access device. As mentioned above, an access device connects users to other users within the network and can also serve as the point of interconnection between a WLAN and a fixed wire network. Each access device can serve multiple users within a defined network area. As a wireless client moves beyond the range of one access device, the wireless client can be automatically handed over to another access device, e.g., a different access point or a wireless access port supported by a wireless switch. In practice, the number of wireless access devices in a given network generally increases with the number of network users and the physical size of the network.

Wireless switch 200 includes a physical housing 202 that surrounds and protects the components of wireless switch 200. The components located inside housing 202 may include a number of electrical components or elements, power supply features (which may include an integrated UPS, one or more voltage regulators, an AC-to-DC voltage converter, a DC-to-DC voltage converter, power supply voltage monitoring and control logic, and the like), memory elements, a processor, etc. A number of features, elements, and components of wireless switch 200 may be accessible from the exterior of housing 202. In this example, most of these accessible and/or viewable features are located at the front face panel of wireless switch 200. In this regard, wireless switch 200 may include, without limitation: one or more system LED lights 204; an out-of-band management port 206; one or more USB ports 208; one or more memory card slots 210; and various Ethernet connectors, jacks, or ports 212.

LED lights 204 are configured to provide a visual indication of the operating condition of wireless switch 200. LED lights 204 may, for example, indicate system status, fan status, thermal status, power status, or the like. One practical embodiment of wireless switch 200 includes a power status indicator that is visible from outside housing 202. For such an embodiment, the power status indicator may be implemented using one or more of the LED lights 204.

Referring to FIG. 3, wireless switch 200 also includes a power cord receptacle 214, which is accessible from the rear of housing 202. For this embodiment, power cord receptacle 214 is configured for compatibility with a standard AC inlet cord, such as an IEC60320 cord or connector.

Out-of-band management port 206 provides an alternate and direct route to the management port of each device that can be used for reconfiguration, troubleshooting, and rebooting. This route is not dependent upon telnet or SNMP packets moving through the LAN/WAN system, and it provides connectivity even when the network is down. In other words, out-of-band management port provides a management interface which allows other networking devices such as routers, laptops computers, remote management entities, other switches, etc. to determine the status of wireless switch 200 and to also control management variables such as configurations, security, load, networking tables, etc. USB port 208 is configured for compatibility with USB devices and USB cables, and wireless switch 200 may include any number of USB ports 208 that are accessible from outside the housing 202.

Memory card slot 210 is suitably configured to receive a compatible nonvolatile memory storage card. In this regard, memory card slots 210 may be designed to accommodate any number of memory card form factors including, without limitation: CompactFlash; Secure Digital (SD); Memory Stick; MultiMediaCard (MMC); ExpressCard; PCMCIA; or SmartMedia (SM). In preferred embodiments, memory card slots 210 are configured to accommodate hot-swappable nonvolatile memory storage devices, such as CompactFlash memory devices. Ethernet connectors 212 facilitate connection of wireless switch 200 to various WLAN or LAN components. In this regard, Ethernet connectors 212 may be realized as standard RJ-45 connectors, standard Small Form-Factor Pluggable (SFP) connectors, or the like.

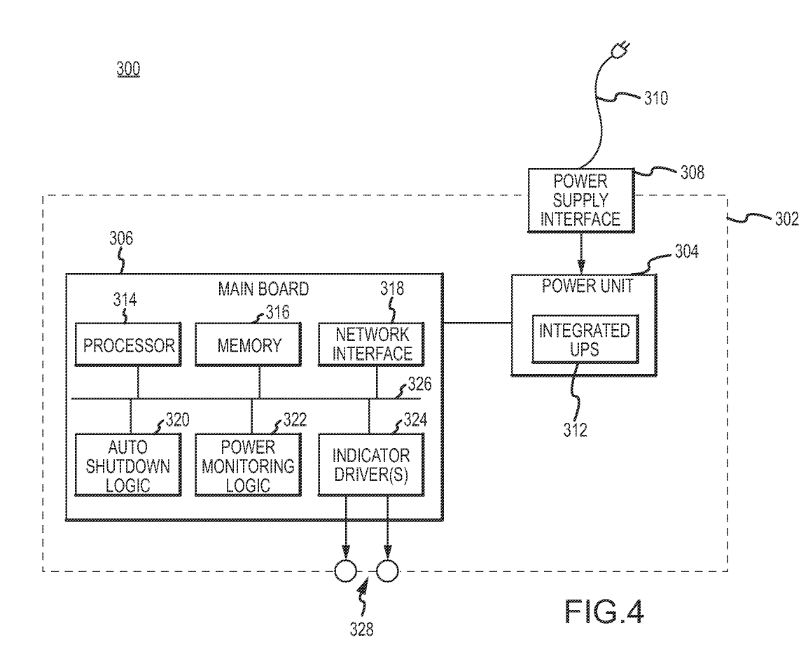

FIG. 4 is a schematic representation of an embodiment of a wireless switch 300. Wireless switch 300 may be realized using the packaging arrangement shown in FIG. 2 and FIG. 3. A practical embodiment of wireless switch 300 will include components and elements configured to support known or conventional operating features that need not be described in detail herein (accordingly, FIG. 4 is a simplified illustration that omits elements that might otherwise be found inside the housing of a wireless switch).

The primary components of wireless switch 300 include, without limitation, a housing 302, a power unit 304 located inside housing 302, and a main board 306 located inside housing 302. Power unit 304 is suitably configured to generate and provide operating power for a plurality of components on main board 306 (and possibly other internal components of wireless switch 300). Main board 306 is coupled to power unit 304 such that main board 306 and the components of main board 306 can receive operating DC voltages from power unit 304.

Wireless switch 300 may include a primary power supply interface 308 that is configured for compatibility with a primary power supply for wireless switch 300. Power supply interface 308 may be realized using hardware, software, firmware, or any combination thereof. FIG. 4 depicts power supply interface 308 coupled to power unit 304. In practice, however, power supply interface 308 (or a portion thereof) may be implemented in power unit 304. In one embodiment of wireless switch 300, power supply interface 308 includes a power cord receptacle (as described above with reference to FIG. 3) that is designed to receive a standard AC power cord 310. In addition, power supply interface 308 may include circuitry and/or logic that enables power unit 304 to receive and operate with the AC voltage delivered via AC power cord 310.

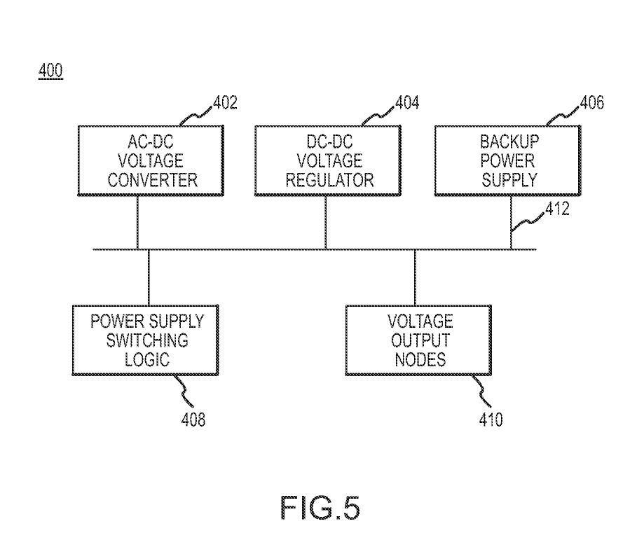

Notably, wireless switch 300 utilizes an integrated UPS 312, which may be realized in power unit 304 as depicted in FIG. 4. Integrated UPS 312 is generally configured to provide backup operating power for components of wireless switch 300 in response to a failure condition of the primary power supply. As used herein, a “failure condition” is any condition that results in out-of-specification voltage characteristics for the primary power supply. For example, a failure condition may be, without limitation: a loss of operating voltage; an operating voltage spike or surge; an operating voltage dip or sag; a frequency disturbance in an AC operating voltage; an under-voltage condition; an over-voltage condition; excessive distortion or noise in the power waveform; or the like. Integrated UPS 312 may be configured to react to the detection of a failure condition of the primary power supply in an appropriate manner. For example, integrated UPS 312 may provide backup operating power for the components of wireless switch 300 until the failure condition is resolved (or until the practical power capacity of integrated UPS 312 has been exhausted). Alternatively or additionally, integrated UPS 312 may be configured to provide backup operating power for wireless switch 300 as needed to enable wireless switch 300 to complete an automatic shutdown procedure. Depending upon the particular implementation of wireless switch 300, integrated UPS 312 may be a standby UPS or a continuous UPS, although preferred embodiments employ a standby UPS. In such preferred embodiments, wireless switch 300 is normally operated using the primary power supply until a failure condition is detected. During such normal operation, the primary AC power supply is used to continuously recharge backup power supply (e.g., a rechargeable battery) such that the battery maintains a full charge. Upon detection of a failure condition, the wireless switch 300 switches to the backup power supply of the integrated UPS. In this regard, the UPS battery provides DC power, and the DC voltage from the UPS battery may be subjected to DC-to-DC conversion to obtain the desired operating voltages. Integrated UPS 312 is described in more detail below with reference to FIG. 5.

For use with one practical embodiment of wireless switch 300, power unit 304 is suitably configured to meet the following specifications: 90-264 VAC input; 47-63 Hz input frequency; and 350 watts DC output. In practice, power unit 304 may be designed to generate 3.3 VDC, 5.0 VDC, and 12 VDC outputs from the input AC voltage, and thereafter regulate the DC output voltages down to appropriate DC voltage levels required to support the various electrical devices and components of wireless switch 300. As mentioned above, power unit 304 is also configured to perform DC-to-DC conversion of the UPS battery voltage, which may be 48 volts in this embodiment. The actual operating voltages may include one or more of the following DC voltages: 0.9 VDC, 1.1 VDC, 1.2 VDC, 1.8 VDC, 2.5 VDC, 3.3 VDC, 5.0 VDC, and 12 VDC.

Main board 306 is coupled to power unit 304 such that main board 306 can receive one or more supply voltages from power unit 304. In practice, main board 306 may include a number of voltage supply rails that carry the different DC voltages generated by power unit 304. For the sake of simplicity and clarity, the individual voltage connections on main board 306 are not depicted in FIG. 4. This particular embodiment of wireless switch 300 includes, without limitation, the following elements and components, which may be realized on main board 306: a processor architecture 314 having suitably configured processing logic; a suitable amount of memory 316; a network interface architecture 318; automatic shutdown logic 320; power monitoring logic 322; and one or more indicator drivers 324. These and other elements of wireless switch 300 may be interconnected together using a bus 326 or any suitable interconnection arrangement. Such interconnection facilitates communication between the various elements of wireless switch 300. A working embodiment of wireless switch 300 may also include components and elements configured to support known or conventional operating features that need not be described in detail herein.

Processor architecture 314 can include any number of physical components or elements. In this regard, processor architecture 314 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Processor architecture 314 is primarily responsible for the general operation of wireless switch 300, e.g., switching, data communication, and data packet processing. In addition, processor architecture 314 may perform a number of operations related to power management and power switching as described in more detail below. Thus, processor architecture 314 represents or includes suitably configured processing logic that carries out the functions, techniques, and processing tasks associated with the operation of wireless switch 300.

Memory 316 may be implemented or realized with RAM memory, flash memory, ROM memory, EPROM memory, EEPROM memory, registers, a hard disk, a removable disk, a CD-ROM, or any other form of storage medium known in the art. Memory 316 can be coupled to processor architecture 314 such that processor architecture 314 can read information from, and write information to, memory 316. In the alternative, memory 316 may be integral to processor architecture 314. As an example, processor architecture 314 and memory 316 may reside in a suitably configured ASIC.

Network interface architecture 318 represents hardware, software, firmware, and/or processing logic that is configured to communicate data (and process that data) between wireless switch 300 and one or more network devices, systems, or applications. In practice, network interface architecture 318 can be configured to support any number of wired and/or wireless data transport schemes and any number of data communication/formatting protocols for compliance with the intended deployment. For data transport over a cable, a wired connection, or other tangible link, network interface architecture 318 may support one or more wired/cabled data communication protocols. Wireless switch 300 can support any number of suitable data communication protocols, techniques, or methodologies, including, without limitation: Ethernet; home network communication protocols; USB; IEEE 1394 (Firewire); hospital network communication protocols; and proprietary data communication protocols. For wireless data transport, network interface architecture 318 may support one or more wireless data communication protocols. Wireless switch 300 may be configured to support any number of suitable wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

Automatic shutdown logic 320 represents processing intelligence and/or a controller that controls a shutdown procedure for wireless switch 300. The shutdown procedure may be initiated in response to the detection of a failure condition of the primary power supply of wireless switch 300. In practice, automatic shutdown logic 320 may be completely or partially realized in processor architecture 314. Moreover, although automatic shutdown logic 320 is depicted on main board 306, it may instead be realized in power unit 304.

Wireless switch 300 may also include suitably configured power monitoring logic 322, which may be completely or partially realized in processor architecture 314. Moreover, although power monitoring logic 322 is depicted on main board 306, it may instead be realized in power unit 304. Power monitoring logic 322 represents processing intelligence and/or a controller that monitors supply voltage conditions and detects onset and resolution of failure conditions associated with one or more power supplies used by wireless switch 300. For example, power monitoring logic 322 may monitor the primary power supply, the main DC voltages derived from the primary power supply, and/or any of the regulated DC voltages generated by power unit 304. In this regard, power monitoring logic 322 may be suitably configured to detect an AC voltage loss failure condition, an AC voltage spike failure condition, an AC voltage dip failure condition, or any of the exemplary failure conditions mentioned above. If any of the monitored supply voltages goes out of specification, power monitoring logic 322 can disable the appropriate DC voltage rails to prevent system damage. Power monitoring logic 322 may also be configured to provide timing and sequencing for system power up, shutdown, and UPS switching.

As described above in connection with FIG. 2, wireless switch 300 may include a power status indicator 328 that is visible from outside housing 302. For example, power status indicator 328 may be realized with one or more LED or other light elements that are illuminated to indicate whether integrated UPS 312 is active, whether the normal primary power supply is active, whether wireless switch 300 is running on its backup power supply, or the like. This embodiment of wireless switch 300 includes one or more suitably configured indicator drivers 324, which are coupled to power status indicator 328. Indicator driver 324 may include hardware, software, circuitry, and/or firmware that controls power status indicator 328 such that power status indicator 328 provides a real-time indication of the power supply state of wireless switch 300. Although indicator driver 324 is depicted on main board 306, it may instead be realized in power unit 304.

FIG. 5 is a schematic representation of an embodiment of a UPS 400 suitable for integration with wireless switch 300. In practice, a wireless switch as described herein may incorporate an integrated UPS having a different configuration than that shown in FIG. 5. A practical embodiment of UPS 400 will include components and elements configured to support known or conventional operating features that need not be described in detail herein (accordingly, FIG. 5 is a simplified illustration that omits elements that might otherwise be included in a UPS).

This embodiment of UPS 400 includes, without limitation: an AC-DC voltage converter 402; a DC-DC voltage regulator 404; a backup power supply 406; power supply switching logic 408; and a number of DC voltage output nodes 410. These and other elements of UPS may be interconnected together using a bus 412 or any suitable interconnection arrangement. Such interconnection facilitates cooperation among the various elements of UPS 400.

AC-DC converter 402 is suitably configured to generate at least one DC supply voltage from an AC voltage (for example, the main AC voltage input of the wireless switch). As described above, a preferred embodiment of AC-DC converter 402 generates three DC voltages from an AC input (having nominal values of 120 VAC and 60 Hz): 3.3 VDC, 5.0 VDC, and 12 VDC. Of course, AC-DC converter 402 may be configured to generate more or less than three DC voltages, and the specific DC voltages are not limited to the values given above.

DC-DC voltage regulator 404 is suitably configured to generate at least one DC supply voltage from the DC voltages provided by AC-DC converter 402. DC-DC voltage regulator 404 may also be configured to generate at least one DC supply voltage from the UPS backup battery voltage. DC-DC voltage regulator 404 may utilize known techniques and technologies to convert the 3.3 VDC, 5.0 VDC, and 12 VDC supply voltages into a number of DC voltages utilized by the components of the wireless switch. These operating DC voltages may include, without limitation: 0.9 VDC, 1.1 VDC, 1.2 VDC, 1.8 VDC, and 2.5 VDC.

Backup power supply 406 represents the power supply that is activated when a failure condition in the primary power supply is detected. In practical embodiments, backup power supply 406 can be a rechargeable battery. In this regard, the battery may be coupled to DC-DC voltage regulator 404 such that the operating DC voltages continue to be generated when the integrated UPS is activated. The battery may be recharged during periods when the integrated UPS is not activated, i.e., when the primary power supply is functioning normally. The output voltage (or voltages), capacity, and other characteristics of backup power supply 406 may be selected according to the specifications of the wireless switch. One exemplary embodiment employs a 48 VDC backup battery.

In certain embodiments, backup power supply 406 may be coupled to a power inverter (not shown) that is suitably configured to convert the DC output voltage of backup power supply 406 into an AC voltage that emulates the primary power supply voltage. For example, the power inverter may be designed to generate a 120 VAC, 60 Hz power signal, which is then processed by AC-DC voltage converter 402 and DC-DC voltage regulator 404 in the manner described above. Using either methodology, the integrated UPS 400 can generate at least one backup DC supply voltage for the components of the wireless switch.

UPS 400 may include power supply switching logic 408, which represents processing intelligence that controls switching between the primary power supply and backup power supply 406 in response to a detected failure condition in the primary power supply. In practice, power supply switching logic 408 causes the primary power supply to be switched out, while initiating the UPS functionality by activating backup power supply 406. In a practical embodiment, power supply switching logic 408 may be configured to cooperate with power monitoring logic 322 (see FIG. 4). Notably, although power supply switching logic 408 is depicted as an element of UPS 400, it may instead be realized elsewhere in the wireless switch (for example, on the main board).

Voltage output nodes 410 represent contact points, electrical conductors, voltage rails, connectors, or any output element of UPS 400 that provides the desired DC output voltages for the wireless switch. In practice, UPS 400 has a voltage output node 410 for each DC voltage generated by UPS. These voltage output nodes 410 may correspond to output nodes of power unit 304, where such output nodes are coupled to main board 306 (see FIG. 4).

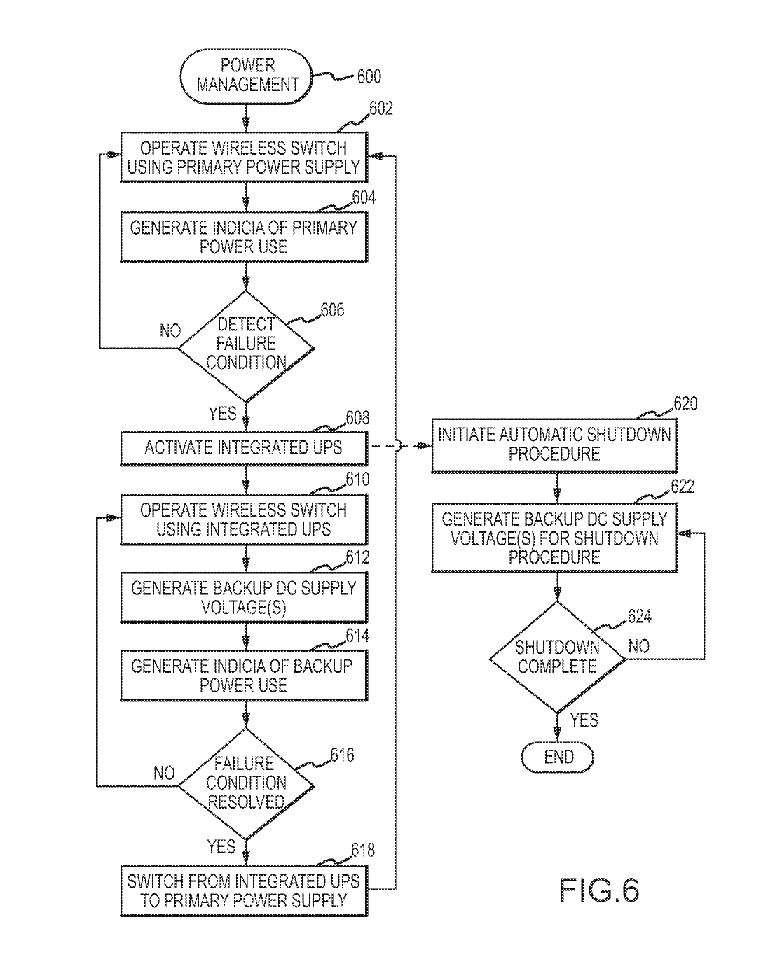

FIG. 6 is a flow chart that illustrates an embodiment of a power management process 600 for a wireless switch. The various tasks performed in connection with process 600 may be performed by software, hardware, firmware, or any combination thereof. For illustrative purposes, the following description of process 600 may refer to elements mentioned above in connection with FIGS. 1-5. In practice, portions of process 600 may be performed by different elements of the described system, e.g., components on a main board of a wireless switch, components in a power unit of a wireless switch, or the like. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein.

For this example, the normal operating mode of the wireless switch relies on a primary power supply. Thus, power management process 600 may begin by operating the wireless switch with the primary power supply (task 602). If the wireless switch includes a power status indicator as described above, then process 600 generates appropriate indicia that is visible from the outside of the wireless switch housing (task 604). This indicia allows an observer to quickly determine that the wireless switch is using the primary power supply at this time. If the wireless switch detects a failure condition of the primary power supply (query task 606), then process 600 may proceed to a UPS mode of operation. If not, then process 600 may continue operating in its normal mode using the primary power supply (thus, the “no” branch of query task 606 may lead back to task 602 or query task 606 may simply idle until a failure condition is detected).

In response to detecting the failure condition, power management process 600 may activate an integrated UPS in the wireless switch (task 608) or otherwise switch the power supply mode to address the failure condition in the primary power supply. Depending upon the given wireless switch configuration and/or the operational settings of the wireless switch, process 600 may support continued operation of the wireless switch using the integrated UPS (task 610). In this regard, the wireless switch may generate at least one backup DC supply voltage (task 612) for components of the wireless switch. Moreover, if the wireless switch includes a power status indicator, then process 600 generates appropriate indicia that is visible from the outside of the wireless switch housing (task 614). This indicia allows an observer to quickly determine that the wireless switch is using the integrated UPS at this time. Accordingly, the power status indicator generates different indicia for the two operating modes (primary power supply mode and UPS mode).

Power management process 600 and the integrated UPS are preferably designed to provide backup power for the wireless switch until the primary power supply is again functioning properly (subject to practical limitations, for example, battery storage capacity and power consumption rates). In this regard, the wireless switch may be configured to determine when the failure condition has been resolved (query task 616). If the wireless switch detects that the failure condition has not been resolved, then process 600 may continue operating in the UPS mode using the backup power supply (thus, the “no” branch of query task 616 may lead back to task 610 or query task 616 may simply idle until the failure condition has been corrected). If, on the other hand, the wireless switch detects that the failure condition has been resolved (query task 616), then process 600 may switch back to its normal operating mode. In other words, the wireless switch can switch from the integrated UPS to the primary power supply (task 618) in response to the determination that the primary power supply is now within specification. Thereafter, process 600 can resume operation of the wireless switch with the primary power supply (FIG. 6 depicts task 618 leading back to task 602, which represents operation using the primary power supply).

Depending upon the given wireless switch configuration and/or the operational settings of the wireless switch, power management process 600 may initiate an automatic shutdown procedure for the wireless switch (task 620) in response to the detection of a failure condition. Such a shutdown procedure may be desirable to protect the wireless switch and/or to maintain the integrity of the data being handled by the wireless switch. In this regard, the wireless switch may generate at least one backup DC supply voltage (task 622) for components of the wireless switch, where the backup DC supply voltages are maintained as necessary to complete the automatic shutdown procedure. In other words, the integrated UPS need not be designed to provide a backup power supply for an indefinite period of time. Accordingly, if the shutdown procedure is not complete (query task 624), then the backup DC power supply voltages continue to be generated. Otherwise, process 600 ends once the shutdown procedure is complete.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A wireless switch for a wireless network, the wireless switch comprising an integrated uninterruptible power supply (UPS) configured to provide operating power for components of the wireless switch in response to a failure condition of a primary power supply for the wireless switch.

2. A wireless switch according to claim 1, wherein:
the primary power supply is an AC power source configured to provide an AC voltage to the wireless switch;
the wireless switch comprises an AC to DC voltage converter configured to generate at least one DC supply voltage from the AC voltage; and
the integrated UPS is configured to generate at least one backup DC supply voltage for the components of the wireless switch.

3. A wireless switch according to claim 1, wherein the integrated UPS is configured to provide operating power for the components of the wireless switch until the failure condition is resolved.

4. A wireless switch according to claim 1, further comprising automatic shutdown logic that controls a shutdown procedure for the wireless switch in response to the failure condition, wherein the integrated UPS is configured to provide operating power necessary to complete the shutdown procedure.

5. A wireless switch according to claim 1, further comprising power supply switching logic that controls switching between the primary power supply and a backup power supply in response to the failure condition.

6. A wireless switch according to claim 1, further comprising power monitoring logic that detects onset of the failure condition.

7. A wireless switch according to claim 6, wherein the power monitoring logic is configured to detect an AC voltage loss failure condition.

8. A wireless switch according to claim 6, wherein the power monitoring logic is configured to detect an AC voltage spike failure condition.

9. A wireless switch according to claim 6, wherein the power monitoring logic is configured to detect an AC voltage dip failure condition.

10. A wireless switch according to claim 1, further comprising:
a housing for components of the wireless switch, including the integrated UPS;
a power status indicator visible from outside the housing; and
a driver coupled to the power status indicator, the driver being configured to control the power status indicator such that the power status indicator indicates whether the integrated UPS is active.

11. A power management method for a wireless switch, the method comprising:
operating the wireless switch with a primary power supply;
detecting a failure condition of the primary power supply;
in response to detecting the failure condition, activating an integrated uninterruptible power supply (UPS) in the wireless switch; and
operating the wireless switch with the integrated UPS.

12. A method according to claim 11, wherein operating the wireless switch with the integrated UPS comprises generating at least one backup DC supply voltage for components of the wireless switch.

13. A method according to claim 11, further comprising:
determining when the failure condition has been resolved; and
in response to the determining step, switching from the integrated UPS to the primary power supply; and
resuming operation of the wireless switch with the primary power supply.

14. A method according to claim 11, further comprising:
in response to detecting the failure condition, initiating an automatic shutdown procedure for the wireless switch;
wherein operating the wireless switch with the integrated UPS comprises generating at least one backup DC supply voltage necessary to complete the automatic shutdown procedure.

15. A method according to claim 11, further comprising:
generating first indicia visible from outside a housing of the wireless switch when operating the wireless switch with the primary power supply; and
generating second indicia visible from outside the housing when operating the wireless switch with the integrated UPS.

16. A wireless switch for a wireless network, the wireless switch comprising:
a housing;
a plurality of components inside the housing;
a power unit inside the housing, the power unit being configured to provide operating power for the plurality of components;
a primary power supply interface coupled to the power unit, the primary power supply interface being configured for compatibility with a primary power supply for the wireless switch; wherein
the power unit comprises an integrated uninterruptible power supply (UPS), the integrated UPS being configured to provide backup operating power for the plurality of components in response to a failure condition of the primary power supply.

17. A wireless switch according to claim 16, further comprising power supply switching logic for the integrated UPS, the power supply switching logic being configured to control switching between the primary power supply and the backup operating power in response to the failure condition.

18. A wireless switch according to claim 16, further comprising power monitoring logic, the power monitoring logic being configured to detect onset of the failure condition.

19. A wireless switch according to claim 16, further comprising:
a power status indicator visible from outside the housing; and
a driver coupled to the power status indicator, the driver being configured to control the power status indicator such that the power status indicator indicates whether the integrated UPS is active.

20. A wireless switch according to claim 16, wherein the integrated UPS is a standby UPS.
